(19) United States
(12) Patent Application Publication
(10) Pub. No.: US 2026/0191160 A1
(43) Pub. Date: Jul. 9, 2026

(54) E.P.E. PEARL COTTON HYDROPONIC COLUMN STRUCTURE

(71) Applicant: Shun-Lung Chou, Yunlin County (TW)

(72) Inventor: Shun-Lung Chou, Yunlin County (TW)

(21) Appl. No.: 19/010,951

(22) Filed: Jan. 6, 2025

(51) Int. Cl. A01G 31/02

(52) U.S. Cl. CPC A01G 31/025

(57) ABSTRACT

An E.P.E. pearl cotton hydroponic column structure includes an E.P.E. pearl cotton hollow tube and two covers mounted on a top and a bottom of the E.P.E. pearl cotton hollow tube respectively. The E.P.E. pearl cotton hollow tube has a cylindrical wall formed with multiple planting slots for receiving multiple containers. Each of the two covers is made of E.P.E. pearl cotton and has a circular shape. Each of the two covers is provided with a hole. A cultivating pipeline includes a tee circulation joint and a sprinkler head connected with the tee circulation joint. The sprinkler head extends through the hole of each of the two covers. In assembly, the top and the bottom of the E.P.E. pearl cotton hollow tube are locked and closed by the two covers.

### BACKGROUND OF THE INVENTION

### Field of the Invention

The present invention relates to a hydroponic device and, more particularly, to an E.P.E. (expanded poly-ethylene) pearl cotton (or E.P.E. foam) hydroponic column structure.

### Description of the Related Art

A conventional vertical hydroponic device or hydroponic column structure 1 in accordance with the prior art shown in FIG. 1 comprises a container 11 for storing nutrient solution and water, and a P.V.C. water pipe 10 mounted on the container 11. The P.V.C. water pipe 10 has a wall provided with multiple holes 100. In use, a planting basket is placed into each of the holes 100 of the container 11 so that the vegetable in the planting basket absorbs the nutrient solution and water in the container 11 and grows gradually. However, the conventional hydroponic column structure 1 has a higher cost and is not worked easily. In addition, the conventional hydroponic column structure 1 has a heavy weight and is difficult to hang vertically, so that the length of the conventional hydroponic column structure 1 is restricted, thereby reducing the quantity of the planting basket. Further, the conventional hydroponic column structure 1 needs a power supply to transport the nutrient solution and water, thereby increasing the expense.

### BRIEF SUMMARY OF THE INVENTION

In accordance with one embodiment of the present invention, there is provided an E.P.E. pearl cotton hydroponic column structure comprising an E.P.E. pearl cotton hollow tube and two covers mounted on a top and a bottom of the E.P.E. pearl cotton hollow tube respectively. The E.P.E. pearl cotton hollow tube has a cylindrical wall formed with multiple planting slots for receiving multiple containers. Each of the two covers is made of E.P.E. pearl cotton and has a circular shape. Each of the two covers is provided with a hole. A cultivating pipeline includes a tee circulation joint and a sprinkler head connected with the tee circulation joint. The sprinkler head extends through the hole of each of the two covers. In assembly, the top and the bottom of the E.P.E. pearl cotton hollow tube are locked and closed by the two covers so that an interior of the E.P.E. pearl cotton hollow tube forms a circulating water flow.

In accordance with another embodiment of the present invention, there is provided an E.P.E. pearl cotton hydroponic column structure comprising an E.P.E. pearl cotton hollow tube, two covers mounted on a top and a bottom of the E.P.E. pearl cotton hollow tube respectively, a second E.P.E. pearl cotton hollow tube mounted in the E.P.E. pearl cotton hollow tube, an overflow pipe mounted in the second E.P.E. pearl cotton hollow tube, and a water-permeable cotton cloth layer coated on the second E.P.E. pearl cotton hollow tube. The E.P.E. pearl cotton hollow tube has a cylindrical wall formed with multiple planting slots for receiving multiple containers. Each of the two covers is made of E.P.E. pearl cotton and has a circular shape. Each of the two covers is provided with a hole. A cultivating pipeline includes a tee circulation joint and a sprinkler head connected with the tee circulation joint. The sprinkler head extends through the hole of each of the two covers. The second E.P.E. pearl cotton hollow tube has a diameter less than an inner diameter of the E.P.E. pearl cotton hollow tube. The overflow pipe has an upper end provided with multiple overflow holes. The water-permeable cotton cloth layer is made of cotton cloth. In assembly, the overflow pipe is locked in a central hole of the second E.P.E. pearl cotton hollow tube, the water-permeable cotton cloth layer covers an outer surface of the second E.P.E. pearl cotton hollow tube and is locked in the E.P.E. pearl cotton hollow tube, and the top and the bottom of the E.P.E. pearl cotton hollow tube are locked and closed by the two covers so that an interior of the E.P.E. pearl cotton hollow tube forms a circulating water flow.

In accordance with another embodiment of the present invention, there is provided an E.P.E. pearl cotton hydroponic column structure comprising an E.P.E. pearl cotton hollow tube, two covers mounted on a top and a bottom of the E.P.E. pearl cotton hollow tube respectively, and a water guide cylinder mounted in the E.P.E. pearl cotton hollow tube. The E.P.E. pearl cotton hollow tube has a cylindrical wall formed with multiple planting slots. Each of the two covers is made of E.P.E. pearl cotton and has a circular shape. Each of the two covers is provided with a hole. The water guide cylinder has a diameter less than an inner diameter of the E.P.E. pearl cotton hollow tube. The water guide cylinder has a surface provided with multiple water guide channels. In assembly, the water guide cylinder is locked in the E.P.E. pearl cotton hollow tube, and the top and the bottom of the E.P.E. pearl cotton hollow tube are locked and closed by the two covers.

According to the primary advantages of the present invention, the E.P.E. pearl cotton hollow tube is made of E.P.E. pearl cotton so that the E.P.E. pearl cotton hydroponic column structure has a lighter weight, a lower cost, and an environmental protection effect. In addition, the E.P.E. pearl cotton hydroponic column structure is hung upward in the air, so that the E.P.E. pearl cotton hollow tube will not contact the soil to avoid disturbance by weeds or pests. Further, the E.P.E. pearl cotton hollow tube has a length that can be adjusted according to the practical requirement, to greatly increase the unit planting area, and to effectively improve the production efficiency of vertical hydroponics. Further, the nutrient solution and water are delivered by the water tower at a higher location, without needing the use of electricity, to avoid the risk of water leakage and electricity leakage.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a conventional hydroponic column structure in accordance with the prior art.

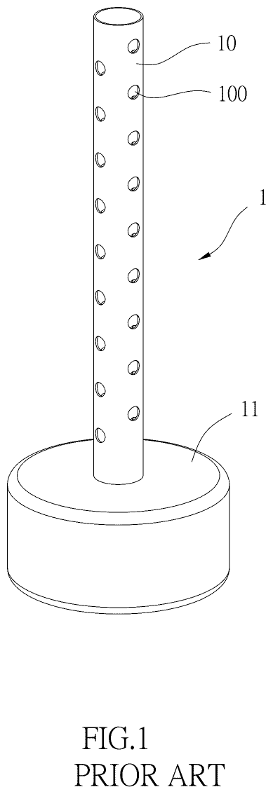

FIG. 2 is an exploded perspective view of an E.P.E. pearl cotton hydroponic column structure in accordance with the preferred embodiment of the

FIG. 3 is a cross-sectional view of the E.P.E. pearl cotton hydroponic column structure in accordance with the preferred embodiment of the present invention.

FIG. 4 is a cross-sectional view of the E.P.E. pearl cotton hydroponic column structure for growing plants.

FIG. 5 is another cross-sectional view of the E.P.E. pearl cotton hydroponic column structure for growing plants.

FIG. 6 is another cross-sectional view of the E.P.E. pearl cotton hydroponic column structure for growing plants.

FIG. 7 is a perspective view of the E.P.E. pearl cotton hydroponic column structure assembled with a cultivating pipeline.

FIG. 8 is another perspective view of the E.P.E. pearl cotton hydroponic column structure assembled with a cultivating pipeline.

FIG. 9 is a schematic perspective view showing a first use of the E.P.E. pearl cotton hydroponic column structure.

FIG. 10 is a schematic perspective view showing a second use of the E.P.E. pearl cotton hydroponic column structure.

FIG. 11 is a schematic perspective view showing a third use of the E.P.E. pearl cotton hydroponic column structure.

FIG. 12 is a schematic perspective view showing a fourth use of the E.P.E. pearl cotton hydroponic column structure.

FIG. 13 is a schematic perspective view showing a fifth use of the E.P.E. pearl cotton hydroponic column structure.

FIG. 14 is an exploded perspective view of an E.P.E. pearl cotton hydroponic column structure in accordance with another preferred embodiment of the present invention.

FIG. 15 is a front cross-sectional assembly view of the E.P.E. pearl cotton hydroponic column structure as shown in FIG. 14.

FIG. 16 is a cross-sectional view showing usage of the E.P.E. pearl cotton hydroponic column structure as shown in FIG. 15.

FIG. 17 is a top cross-sectional assembly view of the E.P.E. pearl cotton hydroponic column structure as shown in FIG. 14.

FIG. 18 is an exploded perspective view of an E.P.E. pearl cotton hydroponic column structure in accordance with a further preferred embodiment of the present invention.

### DETAILED DESCRIPTION OF THE INVENTION

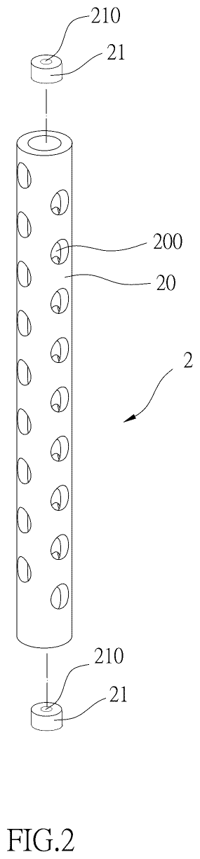

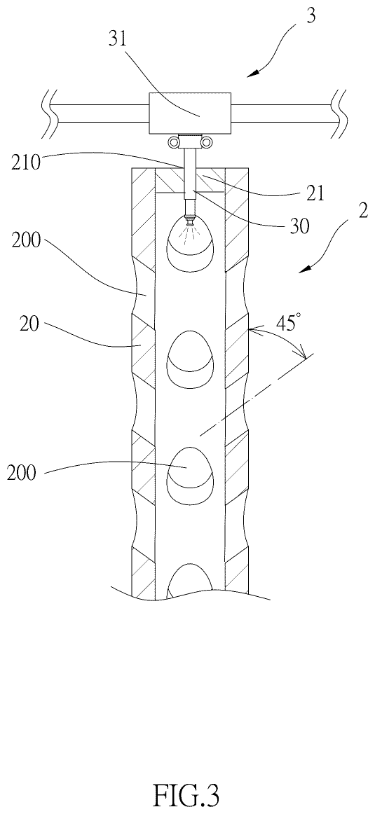

Referring to the drawings and initially to FIGS. 2 and 3, an E.P.E. pearl cotton hydroponic column structure 2 in accordance with the preferred embodiment of the present invention comprises an E.P.E. pearl cotton hollow tube 20 and two covers 21 mounted on a top and a bottom of the E.P.E. pearl cotton hollow tube 20 respectively.

The E.P.E. pearl cotton hollow tube 20 has a cylindrical wall formed with multiple planting slots 200 for receiving multiple containers (or vessels). Each of the two covers 21 is made of E.P.E. pearl cotton and has a circular shape. Each of the two covers 21 is provided with a hole 210. A cultivating pipeline 3 includes a tee circulation joint 31 and a sprinkler head (or water nozzle) 30 connected with the tee circulation joint 31. The sprinkler head 30 extends through the hole 210 of each of the two covers 21 into the E.P.E. pearl cotton hollow tube 20. The sprinkler head 30 is used to spray or drip nutrient solution and water into the E.P.E. pearl cotton hollow tube 20.

In assembly, the top and the bottom of the E.P.E. pearl cotton hollow tube 20 are locked and closed by the two covers 21 so that an interior of the E.P.E. pearl cotton hollow tube 20 forms a circulating water flow.

In the preferred embodiment of the present invention, the planting slots 200 are arranged in more than one row on the E.P.E. pearl cotton hollow tube 20.

In the preferred embodiment of the present invention, each of the planting slots 200 is inclined and directed downward in the cylindrical wall of the E.P.E. pearl cotton hollow tube 20 and forms an inclined angle of 45°as shown in FIG. 3. In practice, the inclined angle is defined between the outer layer and the inner layer of the cylindrical wall of the E.P.E. pearl cotton hollow tube 20. Thus, the thickness of the cylindrical wall of the E.P.E. pearl cotton hollow tube 20 is inclined downward to form the inclined angle.

In the preferred embodiment of the present invention, each of the planting slots 200 has a circular shape or an oval shape.

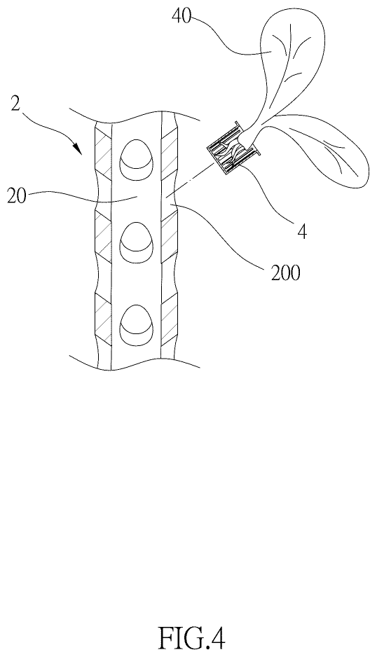

Referring to FIG. 4 with reference to FIGS. 2 and 3, each of the containers is a planting basket 4 for growing plants, such as leafy vegetables 40 or flowers. The planting basket 4 may be locked and secured in one of the planting slots 200 of the E.P.E. pearl cotton hollow tube 20.

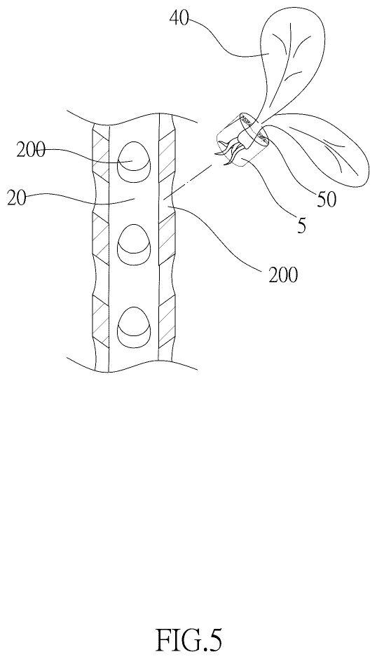

Referring to FIG. 5 with reference to FIGS. 2 and 3, each of the containers is an E.P.E. pearl cotton cylinder 5 formed with a breach 50 for growing the leafy vegetables 40. The E.P.E. pearl cotton cylinder 5 may be locked and secured in one of the planting slots 200 of the E.P.E. pearl cotton hollow tube 20. The E.P.E. pearl cotton cylinder 5 is used to replace a planting basket with a higher cost. Thus, the E.P.E. pearl cotton cylinder 5 is made easily and has a lower price, to reduce the cost of the E.P.E. pearl cotton hydroponic column structure 2.

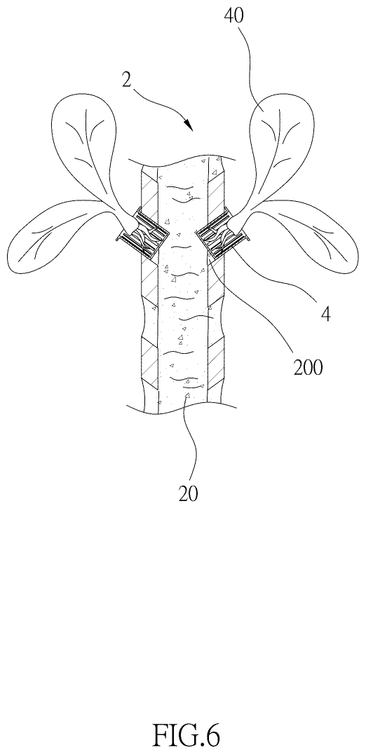

Referring to FIG. 6 with reference to FIGS. 2 and 3, the planting basket 4 is locked and fixed in each of the planting slots 200 of the E.P.E. pearl cotton hollow tube 20, with the roots of the leafy vegetables 40 protruding from the cylindrical wall of the E.P.E. pearl cotton hollow tube 20 into the E.P.E. pearl cotton hollow tube 20. Thus, the sprinkler head 30 may spray or drip the nutrient solution and water into the E.P.E. pearl cotton hollow tube 20, so that the nutrient solution and water are absorbed by the roots of the leafy vegetables 40, thereby finishing the hydroponic cultivation.

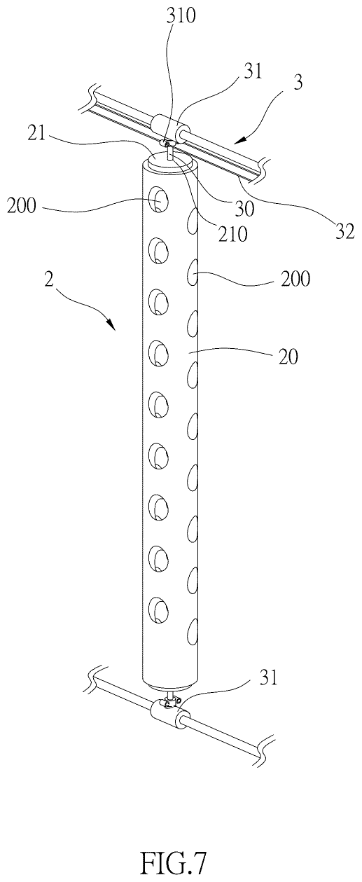

Referring to FIG. 7 with reference to FIGS. 2 and 3, the tee circulation joint 31 has two through holes 310, and two steel wires (or ropes) 32 extend through the two through holes 310 of the tee circulation joint 31 of the cultivating pipeline 3.

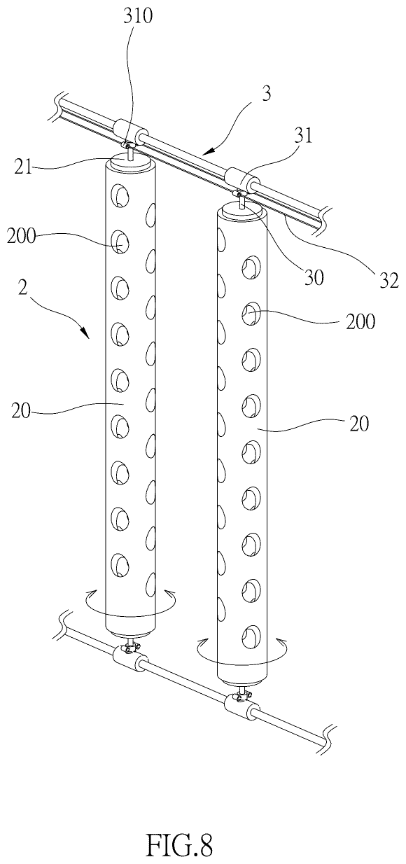

Referring to FIG. 8 with reference to FIGS. 2 and 3, the sprinkler head 30 is inserted through the hole 210 of each of the two covers 21. In addition, the sprinkler head 30 is rotatably connected with the tee circulation joint 31 so that the E.P.E. pearl cotton hollow tube 20 is rotatable relative to the cultivating pipeline 3 to adjust the angle of each of the planting slots 200 of the E.P.E. pearl cotton hollow tube 20 facing the sunlight, so that the planting basket 4 is fully exposed to the sunlight, to meet the growth condition of the leafy vegetables 40.

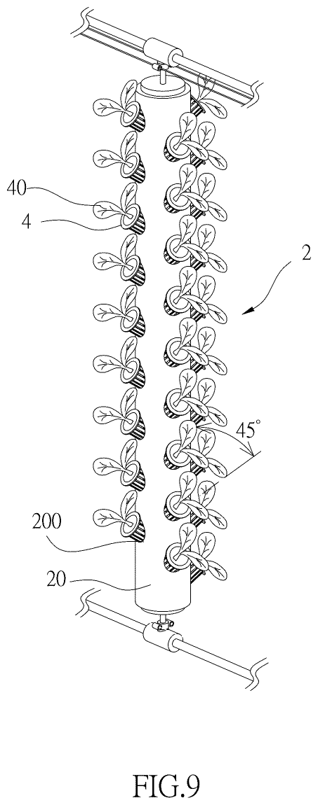

Referring to FIG. 9 with reference to FIGS. 2 and 3, the planting baskets 4 are placed into the planting slots 200 of the E.P.E. pearl cotton hollow tube 20. At this time, each of the planting slots 200 is inclined and directed downward in the cylindrical wall of the E.P.E. pearl cotton hollow tube 20 and forms an inclined angle of 45°. Thus, the planting baskets 4 are locked and secured in the planting slots 200 of the E.P.E. pearl cotton hollow tube 20, with the roots of the leafy vegetables 40 absorbing the nutrient solution in the E.P.E. pearl cotton hollow tube 20.

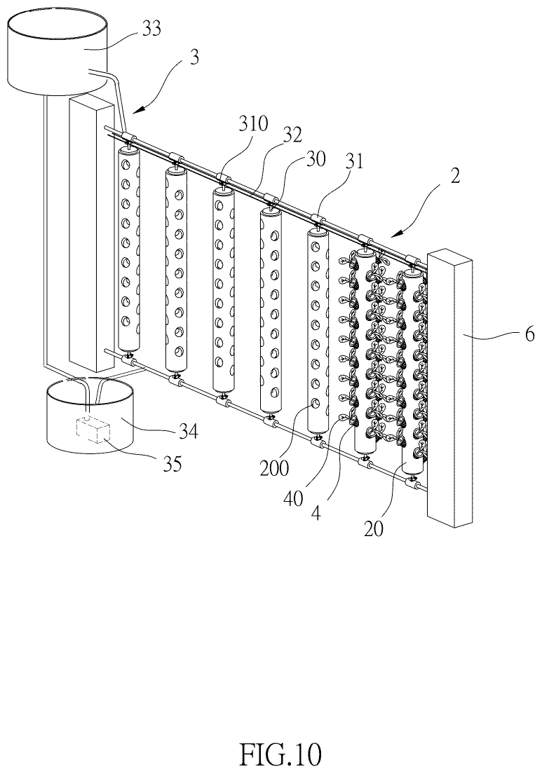

Referring to FIG. 10 with reference to FIGS. 2 and 3, the two steel wires 32 extend through the two through holes 310 of the tee circulation joint 31 of the cultivating pipeline 3. Then, the two ends of each of the two steel wires 32 are secured to two walls 6, so that multiple E.P.E. pearl cotton hydroponic column structures 2 are hung in the air. Thus, the planting baskets 4 are hung upward so that the leafy vegetables 40 are spaced from the ground and will not contact with the soil, to avoid disturbance by weeds or pests. A water tower 33 is located above the E.P.E. pearl cotton hydroponic column structures 2 and connected to the cultivating pipeline 3 to supply a liquid, such as nutrient solution and water. The liquid flows through the sprinkler head 30 into the E.P.E. pearl cotton hollow tube 20 so that the liquid from the water tower 33 freely flows downward into the E.P.E. pearl cotton hollow tube 20. Thus, the liquid is distributed on the cylindrical wall of the E.P.E. pearl cotton hollow tube 20 and is absorbed by the roots of the leafy vegetables 40. Then, the residual liquid flows through the cultivating pipeline 3 under the E.P.E. pearl cotton hollow tube 20 into a water collecting tank 34, and is pumped by a pump 35 and returned to the water tower 33, thereby forming a circulation of water flow.

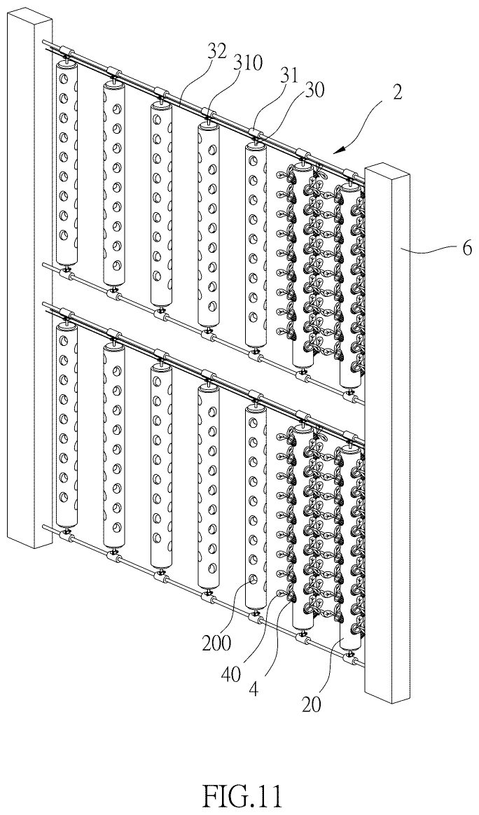

Referring to FIG. 11 with reference to FIG. 10, the E.P.E. pearl cotton hydroponic column structures 2 are arranged in two rows from top to bottom.

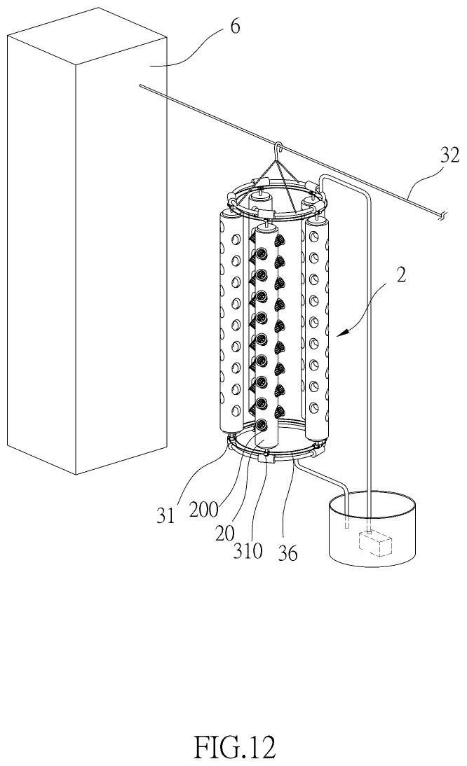

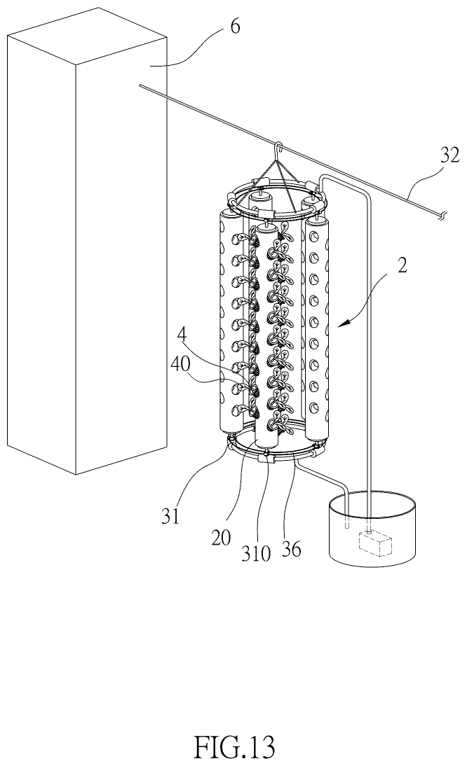

Referring to FIGS. 12 and 13 with reference to FIG. 10, the two through holes 310 of the tee circulation joint 31 of the cultivating pipeline 3 are mounted on an annular steel wire 36. Then, the annular steel wire 36 is hung on a steel wire 32 which is stretched between the two walls 6. Thus, the E.P.E. pearl cotton hydroponic column structures 2 are hung in the air in annular arrangement for mounting the planting baskets 4 with the leafy vegetables 40.

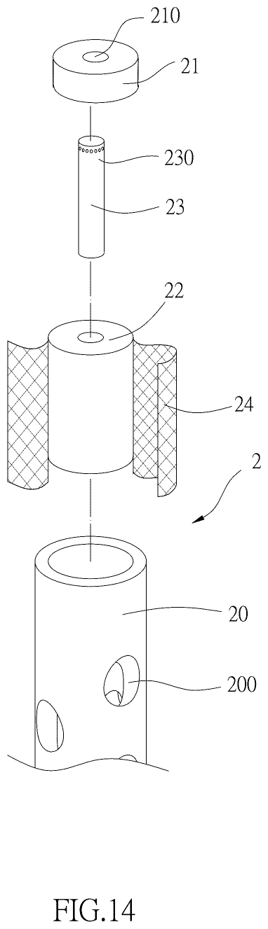

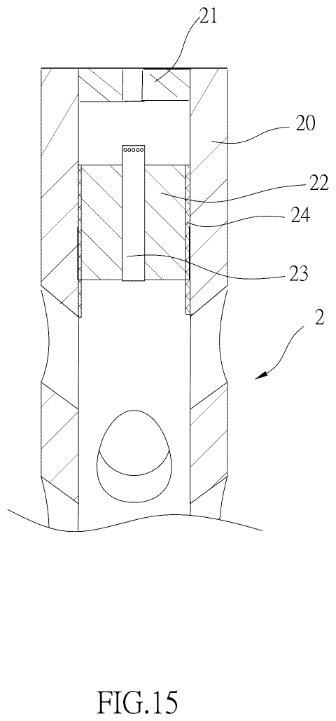

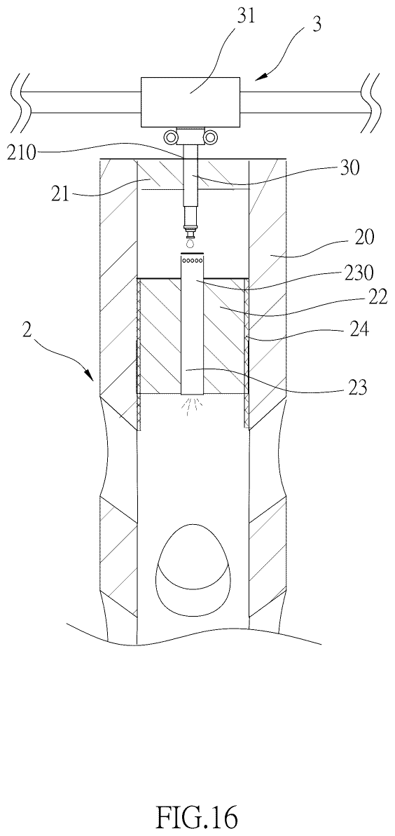

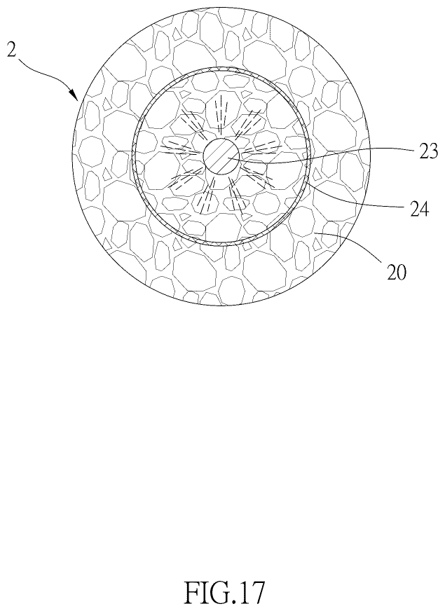

Referring to FIGS. 14-17, an E.P.E. pearl cotton hydroponic column structure 2 in accordance with another preferred embodiment of the present invention comprises an E.P.E. pearl cotton hollow tube 20 (or a first E.P.E. pearl cotton hollow tube 20), two covers 21 mounted on a top and a bottom of the E.P.E. pearl cotton hollow tube 20 respectively, a second E.P.E. pearl cotton hollow tube 22 mounted in the E.P.E. pearl cotton hollow tube 20, an overflow pipe 23 mounted in the second E.P.E. pearl cotton hollow tube 22, and a water-permeable cotton cloth layer 24 coated on the second E.P.E. pearl cotton hollow tube 22.

The E.P.E. pearl cotton hollow tube 20 has a cylindrical wall formed with multiple planting slots 200 for receiving multiple containers (or vessels). Each of the two covers 21 is made of E.P.E. pearl cotton and has a circular shape. Each of the two covers 21 is provided with a hole 210. A cultivating pipeline 3 includes a tee circulation joint 31 and a sprinkler head (or water nozzle) 30 connected with the tee circulation joint 31. The sprinkler head 30 extends through the hole 210 of each of the two covers 21 into the E.P.E. pearl cotton hollow tube 20. The second E.P.E. pearl cotton hollow tube 22 has a diameter less than an inner diameter of the E.P.E. pearl cotton hollow tube 20. The overflow pipe 23 is preferably made of metal or hard plastics and has a closed top. The overflow pipe 23 has an upper end provided with multiple overflow holes 230. The water-permeable cotton cloth layer 24 is made of cotton cloth.

In assembly, the overflow pipe 23 is locked in a central hole of the second E.P.E. pearl cotton hollow tube 22, the water-permeable cotton cloth layer 24 covers an outer surface of the second E.P.E. pearl cotton hollow tube 22 and is inserted into and locked in the E.P.E. pearl cotton hollow tube 20, and the top and the bottom of the E.P.E. pearl cotton hollow tube 20 are locked and closed by the two covers 21 so that an interior of the E.P.E. pearl cotton hollow tube 20 forms a circulating water flow.

In use, a little amount of the liquid, such as nutrient solution and water, flows or drips through the sprinkler head 30 into the E.P.E. pearl cotton hollow tube 20 and is absorbed by the water-permeable cotton cloth layer 24, so that the liquid is guided to and evenly distributed on the cylindrical wall of the E.P.E. pearl cotton hollow tube 20, to facilitate the roots of the leafy vegetables absorbing the liquid. When the input amount is excessive, the liquid is guided through the overflow holes 230 into the overflow pipe 23. Then, the excess liquid in turn flows through the lower end of the overflow pipe 23 and is shunted to the water-permeable cotton cloth layer 24, and is guided to the cylindrical wall of the E.P.E. pearl cotton hollow tube 20 to be absorbed by the roots of the leafy vegetables.

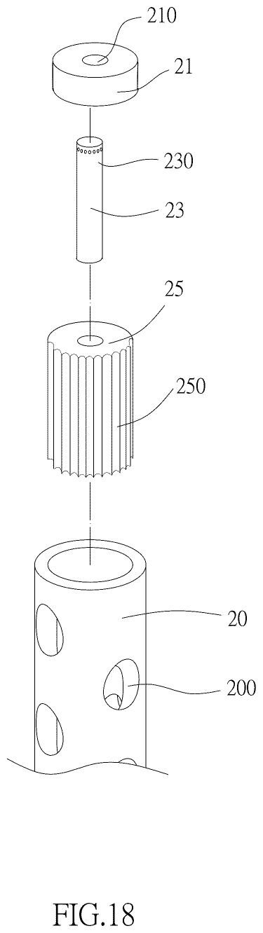

Referring to FIG. 18, an E.P.E. pearl cotton hydroponic column structure 2 in accordance with a further preferred embodiment of the present invention comprises an E.P.E. pearl cotton hollow tube 20, two covers 21 mounted on a top and a bottom of the E.P.E. pearl cotton hollow tube 20 respectively, and a water guide cylinder 25 mounted in the E.P.E. pearl cotton hollow tube 20.

The E.P.E. pearl cotton hollow tube 20 has a cylindrical wall formed with multiple planting slots 200 for receiving multiple containers (or vessels). Each of the two covers 21 is made of E.P.E. pearl cotton and has a circular shape. Each of the two covers 21 is provided with a hole 210. The water guide cylinder 25 has a diameter less than an inner diameter of the E.P.E. pearl cotton hollow tube 20. The water guide cylinder 25 has a surface provided with multiple water guide channels 250. The water guide cylinder 25 is preferably made of a metal tube or a hard plastic tube.

In assembly, the water guide cylinder 25 is inserted into and locked in the E.P.E. pearl cotton hollow tube 20, and the top and the bottom of the E.P.E. pearl cotton hollow tube 20 are locked and closed by the two covers 21 so that an interior of the E.P.E. pearl cotton hollow tube 20 forms a circulating water flow. Thus, the liquid, such as nutrient solution and water, flows through the water guide channels 250 of the water guide cylinder 25 into the E.P.E. pearl cotton hollow tube 20, and is guided to and evenly distributed on the cylindrical wall of the E.P.E. pearl cotton hollow tube 20, to facilitate the roots of the leafy vegetables absorbing the liquid. In such a manner, only a small amount of nutrient solution and water is needed to supply the roots of the leafy vegetables close to the inner wall of the E.P.E. pearl cotton hollow tube 20 for absorption and growth, thereby reducing the cost of water resources and nutrient solution.

Accordingly, the E.P.E. pearl cotton hollow tube 20 is made of E.P.E. pearl cotton so that the E.P.E. pearl cotton hydroponic column structure 2 of the present invention has a lighter weight, a lower cost, and an environmental protection effect. In addition, the E.P.E. pearl cotton hydroponic column structure 2 is hung upward in the air, so that the E.P.E. pearl cotton hollow tube 20 will not contact the soil to avoid disturbance by weeds or pests. Further, the E.P.E. pearl cotton hollow tube 20 has a length (or height) that can be adjusted according to the practical requirement, to greatly increase the unit planting area, and to effectively improve the production efficiency of vertical hydroponics. Further, the nutrient solution and water are delivered by the water tower 33 at a higher location, without needing the use of electricity, to avoid the risk of water leakage and electricity leakage.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An E.P.E. pearl cotton hydroponic column structure comprising:
an E.P.E. pearl cotton hollow tube; and
two covers mounted on a top and a bottom of the E.P.E. pearl cotton hollow tube respectively;
wherein:
the E.P.E. pearl cotton hollow tube has a cylindrical wall formed with multiple planting slots for receiving multiple containers;
each of the two covers is made of E.P.E. pearl cotton and has a circular shape;
each of the two covers is provided with a hole;
a cultivating pipeline includes a tee circulation joint and a sprinkler head connected with the tee circulation joint;
the sprinkler head extends through the hole of one of the two covers;
the planting slots are arranged in more than one row on the E.P.E. pearl cotton hollow tube;
each of the planting slots is inclined and directed downward in the cylindrical wall of the E.P.E. pearl cotton hollow tube and forms an inclined angle of 45°;
the sprinkler head is rotatably connected with the tee circulation joint so that the E.P.E. pearl cotton hollow tube is rotatable to adjust an angle of the E.P.E. pearl cotton hollow tube;
each of the containers is a planting basket for growing plants; and
in assembly, the top and the bottom of the E.P.E. pearl cotton hollow tube are locked and closed by the two covers so that an interior of the E.P.E. pearl cotton hollow tube forms a circulating water flow.

2. The E.P.E. pearl cotton hydroponic column structure as claimed in claim 1, wherein the planting slots are fully hidden in the E.P.E. pearl cotton hollow tube without protruding from the E.P.E. pearl cotton hollow tube.

3. The E.P.E. pearl cotton hydroponic column structure as claimed in claim 1, wherein each of the planting slots has a thickness equal to that of the cylindrical wall of the E.P.E. pearl cotton hollow tube.

4. The E.P.E. pearl cotton hydroponic column structure as claimed in claim 1, wherein each of the planting slots has a circular shape.

5. The E.P.E. pearl cotton hydroponic column structure as claimed in claim 1, wherein the hole extends through a length of each of the two covers. that

6. The E.P.E. pearl cotton hydroponic column structure as claimed in claim 1, wherein the hole has a length equal to that of each of the two covers.

7. The E.P.E. pearl cotton hydroponic column structure as claimed in claim 1, wherein the containers are inserted through the planting slots of the E.P.E. pearl cotton hollow tube, and each of the containers partially extends into the interior of the E.P.E. pearl cotton hollow tube and partially protrudes from one of the planting slots of the E.P.E. pearl cotton hollow tube.

8. An E.P.E. pearl cotton hydroponic column structure comprising:
an E.P.E. pearl cotton hollow tube;
two covers mounted on a top and a bottom of the E.P.E. pearl cotton hollow tube respectively;
a second E.P.E. pearl cotton hollow tube mounted in the E.P.E. pearl cotton hollow tube;
an overflow pipe mounted in the second E.P.E. pearl cotton hollow tube; and
a water-permeable cotton cloth layer coated on the second E.P.E. pearl cotton hollow tube;
wherein:
the E.P.E. pearl cotton hollow tube has a cylindrical wall formed with multiple planting slots for receiving multiple containers;
each of the two covers is made of E.P.E. pearl cotton and has a circular shape;
each of the two covers is provided with a hole;
a cultivating pipeline includes a tee circulation joint and a sprinkler head connected with the tee circulation joint;
the sprinkler head extends through the hole of each of the two covers;
the second E.P.E. pearl cotton hollow tube has a diameter less than an inner diameter of the E.P.E. pearl cotton hollow tube;
the overflow pipe has an upper end provided with multiple overflow holes;
the water-permeable cotton cloth layer is made of cotton cloth;
in assembly, the overflow pipe is locked in a central hole of the second E.P.E. pearl cotton hollow tube, the water-permeable cotton cloth layer covers an outer surface of the second E.P.E. pearl cotton hollow tube and is locked in the E.P.E. pearl cotton hollow tube, and the top and the bottom of the E.P.E. pearl cotton hollow tube are locked and closed by the two covers so that an interior of the E.P.E. pearl cotton hollow tube forms a circulating water flow.

9. The E.P.E. pearl cotton hydroponic column structure as claimed in claim 8, wherein the planting slots are arranged in more than one row on the E.P.E. pearl cotton hollow tube.

10. The E.P.E. pearl cotton hydroponic column structure as claimed in claim 8, wherein each of the planting slots is inclined and directed downward in the cylindrical wall of the E.P.E. pearl cotton hollow tube and forms an inclined angle of 45°.

11. The E.P.E. pearl cotton hydroponic column structure as claimed in claim 8, wherein the sprinkler head is rotatably connected with the tee circulation joint so that the E.P.E. pearl cotton hollow tube is rotatable to adjust an angle of the E.P.E. pearl cotton hollow tube.

12. The E.P.E. pearl cotton hydroponic column structure as claimed in claim 8, wherein each of the containers is an E.P.E. pearl cotton cylinder formed with a breach.

13. The E.P.E. pearl cotton hydroponic column structure as claimed in claim 8, wherein the overflow pipe is made of metal or hard plastics and has a closed top.

14. An E.P.E. pearl cotton hydroponic column structure comprising:
an E.P.E. pearl cotton hollow tube;
two covers mounted on a top and a bottom of the E.P.E. pearl cotton hollow tube respectively; and
a water guide cylinder mounted in the E.P.E. pearl cotton hollow tube;
the E.P.E. pearl cotton hollow tube has a cylindrical wall formed with multiple planting slots;
each of the two covers is made of E.P.E. pearl cotton and has a circular shape;
each of the two covers is provided with a hole;
the water guide cylinder has a diameter less than an inner diameter of the E.P.E. pearl cotton hollow tube;
the water guide cylinder has a surface provided with multiple water guide channels;
in assembly, the water guide cylinder is locked in the E.P.E. pearl cotton hollow tube, and the top and the bottom of the E.P.E. pearl cotton hollow tube are locked and closed by the two covers.

15. The E.P.E. pearl cotton hydroponic column structure as claimed in claim 14, wherein the planting slots are arranged in more than one row on the E.P.E. pearl cotton hollow tube.

16. The E.P.E. pearl cotton hydroponic column structure as claimed in claim 14, wherein each of the planting slots is inclined and directed downward in the cylindrical wall of the E.P.E. pearl cotton hollow tube and forms an inclined angle of 45°.
